(19) United States
(12) Patent Application Publication
(10) Pub. No.: US 2015/0213377 A1
(43) Pub. Date: Jul. 30, 2015

(54) INFORMATION PROCESSING APPARATUS, INFORMATION PROCESSING METHOD, AND INFORMATION PROCESSING PROGRAM

(71) Applicant: RAKUTEN, INC., Tokyo (JP)

(72) Inventors: Masanaka Ito, Tokyo (JP); Ryohei Takuma, Tokyo (JP)

(73) Assignee: RAKUTEN, INC., Tokyo (JP)

(21) Appl. No.: 14/424,065

(22) PCT Filed: Apr. 9, 2013
(86) PCT No.: PCT/JP2013/060682

§ 371 Date: Feb. 26, 2015

(30) Foreign Application Priority Data
Sep. 14, 2012 (JP) 2012-203238

(51) Int. Cl. G06Q 10/02; G06F 17/30

(52) U.S. Cl. CPC G06Q 10/02; G06F 17/30864

(57) ABSTRACT

Places that are reservable for a time period desired by a user are flexibly searched for. An information processing apparatus identifies a desired time period for a user to use a place. The information processing apparatus searches for places reservable throughout the identified desired time period. The information processing apparatus also searches for combinations of two or more places that would be reservable continuously throughout the desired time period if the place to be reserved were changed during the identified desired time period. Then the information processing apparatus causes the result of the search for places reservable throughout the desired time period and the result of the search for combinations of two or more places reservable continuously throughout the desired time period to be presented in a mutually distinguishable form.

### TECHNICAL FIELD

The present invention relates to a technical field of an information processing apparatus and an information processing method for searching for places that are reservable for a time period desired by a user.

### BACKGROUND ART

Technologies for searching for reservable places using a network are conventionally known. For example, Patent Literature 1 discloses that a meeting room is determined to be available if the meeting room is not reserved throughout one or more time periods, each having a unit time length, that constitute a desired time period input by a reservation applicant, and that a meeting room is determined to be already reserved if the meeting room is reserved for at least one of the time periods.

### CITATION LIST

### Patent Literature

Patent Literature 1: JP 2011-48505 A

### SUMMARY OF INVENTION

### Technical Problem

Unfortunately, a place retrieved by the technology disclosed in Patent Literature 1 is limited to a place reservable throughout the desired time period.

In view of the above point, it is an object of the present invention to provide an information processing apparatus, an information processing method, and an information processing program that allows a flexible search for places reservable for a time period desired by a user.

### Solution to Problem

In order to solve the above problem, the invention according to claim 1 is an information processing apparatus comprising: an identifying means that identifies a desired time period for a user to use a place; a first search means that searches for places reservable throughout the desired time period identified by the identifying means; a second search means that searches for combinations of two or more places that would be reservable continuously throughout the desired time period identified by the identifying means if a place to be reserved were changed during the desired time period; and a presentation control means that causes a search result by the first search means and a search result by the second search means to be presented in a mutually distinguishable form.

If a user can use any places during a desired time period, the user can achieve an object to do something using places, without using one place throughout the desired time period. The user has only to change the place which is to be used, during the desired time period. According to the invention, the result of the search for combinations of two or more places that would be reservable continuously throughout the desired time period if the place to be reserved were changed during the desired time period is presented in a form distinguishable from the result of the search for places reservable throughout the desired time period. Therefore, it is possible to flexibly search for places that are reservable for a time period desired by a user.

The invention according to claim 2 is the information processing apparatus according to claim 1, further comprising a determining means that determines ease of moving between the places included in the combination(s) retrieved by the second search means, wherein among the combination(s) retrieved by the second search means, the presentation control means causes the combination(s) with ease, determined by the determining means, equal to or greater than predetermined ease to be presented.

According to the invention, among the retrieved combination(s), the combination(s) with ease of moving between the meeting rooms included in the combination(s) that is equal to or greater than the predetermined ease are presented. Thus, only the convenient combination(s) to move can be presented, so that the user can easily find a convenient combination to move from the search result.

The invention according to claim 3 is the information processing apparatus according to claim 2, wherein when a positional relationship between a source place and a destination place is closer, the determining means determines that it is easier to move.

According to the invention, the ease of move is determined based on the positional relationship between the source place and destination place, so that the ease of move can be properly determined.

The invention according to claim 4 is the information processing apparatus according to claim 2 or 3, wherein when the number of the places included in the combination retrieved by the second search means is smaller, the presentation control means determines that it is easier to move.

According to the invention, the ease of move is determined based on the number of the places included in the combination, so that the ease of move can be properly determined.

The invention according to claim 5 is an information processing method performed by a computer, the method comprising: an identifying step of identifying a desired time period for a user to use a place; a first search step of searching for places reservable throughout the desired time period identified in the identifying step; a second search step of searching for combinations of two or more places that would be reservable continuously throughout the desired time period identified in the identifying step if a place to be reserved were changed during the desired time period; and a presentation control step of causing a search result in the first search step and a search result in the second search step to be presented in a mutually distinguishable form.

The invention according to claim 6 is an information processing program for causing a computer to function as: an identifying means that identifies a desired time period for a user to use a place; a first search means that searches for places reservable throughout the desired time period identified by the identifying means; a second search means that searches for combinations of two or more places that would be reservable continuously throughout the desired time period identified by the identifying means if a place to be reserved were changed during the desired time period; and a presentation control means that causes a search result by the first search means and a search result by the second search means to be presented in a mutually distinguishable form.

### Advantageous Effects of Invention

According to the present invention, the result of the search for combinations of two or more places that would be reservable continuously throughout the desired time period if the place to be reserved were changed during the desired time period is presented in a form distinguishable from the result of the search for places reservable throughout the desired time period. Therefore, it is possible to flexibly search for places that are reservable for a time period desired by a user.

### BRIEF DESCRIPTION OF DRAWINGS

FIG. 1 is a diagram showing an example of a schematic configuration of an information processing system S according to an embodiment.

FIG. 2A is a diagram showing an example of the reservation status of meeting rooms. FIG. 2B is a diagram showing an example of calculation bases for an ease-of-move score.

FIG. 3 is a sequence diagram showing a process overview of the information processing system S according to an embodiment.

FIG. 4A is a diagram showing a display example of a search result page. FIG. 4B is a diagram showing a display example of a search result page when a meeting room is reservable throughout a desired time period.

FIG. 5 is a block diagram showing an example of a schematic configuration of a meeting room reservation server 1 according to an embodiment.

FIG. 6A is a diagram showing an example of information registered in a user information DB 12a. FIG. 6B is a diagram showing an example of information registered in a meeting room information DB 12b. FIG. 6C is a diagram showing an example of information registered in a reservation status DB 12c. FIG. 6D is a diagram showing an example of information registered in a reservation information DB 12d.

FIG. 7 is a diagram showing an example of functional blocks of the meeting room reservation server 1 according to an embodiment.

FIG. 8 is a flowchart showing an example process of a search process performed by a system controller 14 of the meeting room reservation server 1 according to an embodiment.

FIG. 9 is a flowchart showing an example process of a score calculation process performed by the system controller 14 of the meeting room reservation server 1 according to an embodiment.

### DESCRIPTION OF EMBODIMENTS

An embodiment of the present invention will now be described with reference to the drawings. The embodiment described below is an embodiment in which the present invention is applied to an information processing system.

### 1. Configuration and Functional Overview of Information Processing System

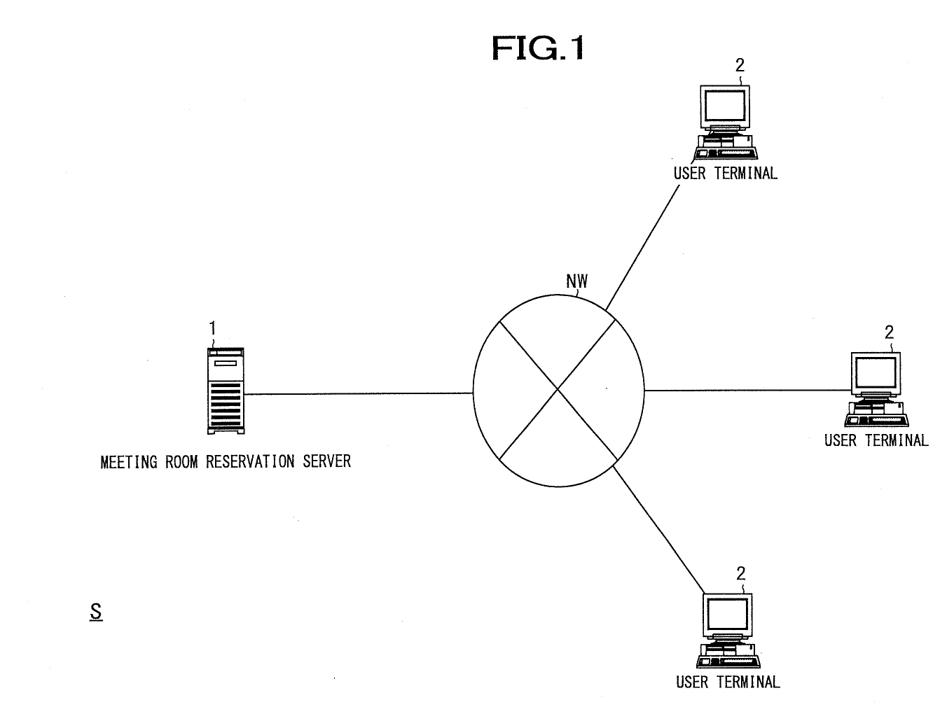

First, a configuration of an information processing system S according to the embodiment will be described with reference to FIG. 1. FIG. 1 is a diagram showing an example of a schematic configuration of the information processing system S according to the embodiment.

As shown in FIG. 1, the information processing system S includes a meeting room reservation server 1 and a plurality of user terminals 2. The meeting room reservation server 1 can exchange data with each user terminal 2 via a network NW using communication protocols, such as TCP/IP. The network NW includes, for example, the Internet, a dedicated communication line (e.g., community antenna television (CATV) line), a mobile communication network (including a base station), and a gateway.

The meeting room reservation server 1 is a server device that performs various processes related to a reservation site for reserving meeting rooms. The meeting room reservation server 1 is an example of an information processing apparatus according to the present invention. A user can reserve the use of any meeting room from a plurality of meeting rooms through the reservation site. A meeting room is an example of a place according to the present invention. The meeting room reservation server 1, for example, sends web pages of the reservation site and performs processing related to meeting room searches, reservations, and the like, in response to requests from the user terminal 2.

The user terminal 2 is a terminal device of a user who uses the reservation site. The user, for example, may be able to use the reservation site by signing up for the reservation site. Alternatively, each employee of a certain company may be able to use the reservation site as a user. The user terminal 2 accesses the meeting room reservation server 1 in response to an operation by the user and receives a web page from the meeting room reservation server 1 to display the web page. The user terminal 2 has software, such as a browser and an e-mail client, installed on it. For example, a personal computer, a personal digital assistant (PDA), a portable information terminal such as a smartphone, and a mobile phone are used as the user terminal 2.

### 2. Search for Meeting Rooms

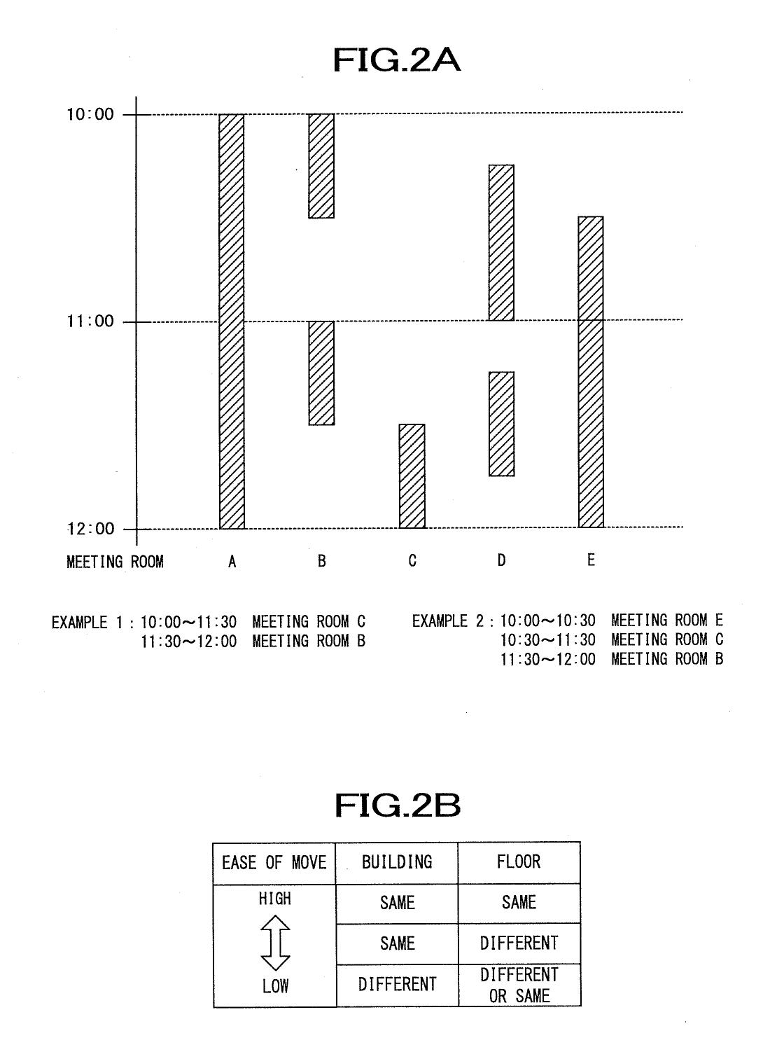

The following describes a search for meeting rooms with reference to FIGS. 2A to 4. The reservation site provides a plurality of time slots for a user to use a meeting room. The time slot is a time period corresponding to the length of a unit time for the use of a meeting room. The user can reserve a meeting room for each time slot. The length of the time slot is freely-set. In this embodiment, the length of the time slot is, for example, 15 minutes. In this case, for instance, the time slot from 10:00 to 10:15, the time slot from 10:15 to 10:30, etc. are provided. The length and the start time of each time slot may be common to all meeting rooms.

The user can specify a scheduled date and a desired time period as search criteria when searching for meeting rooms on the reservation site. The desired time period is a time period which the user desires for the use of a meeting room. The user can specify a desired time period corresponding to one or more time slots. For example, the user may be able to specify the start time and end time of the desired time period. Alternatively, the user, for example, may be able to specify the start time and the number of time slots of the desired time period. The user can specify a desired time period corresponding to two or more continuous time slots. For example, the user can specify the time period from 10:00 to 11:30. The two or more continuous time slots are referred to as “continuous slots”. The number of the time slots constituting the continuous slots is referred to as a “slot count”. The continuous slots with a slot count of n is referred to as an n-continuous slots. In addition to the scheduled date and the desired time period, for example, the seating capacity and the location of a meeting room may be able to be specified as the search criteria.

In response to a search request including a desired time period specified by a user, the meeting room reservation server 1 searches for meeting rooms reservable throughout the desired time period. The meeting room reservable throughout the desired time period is a meeting room that is reservable throughout one or more time slots corresponding to the desired time period. A reservable time slot is a time slot for which is not yet reserved by anyone. Such a time slot is referred to as an “available slot”. A time slot already reserved is referred to as a “reserved slot”. When a time period corresponding to continuous slots as a desired time period is specified, the meeting room reservation server 1 searches for meeting rooms that are available throughout all time slots constituting the continuous slots corresponding to the desired time period.

Assume that a time period corresponding to continuous slots as a desired time period is specified. In this case, the user can not reserve a meeting room that is reserved for at least one of the time slots included in the desired time period. If all meeting rooms are in such a state, the user can not reserve any meeting room for the desired time period. If the number of meeting rooms reservable throughout the desired time period is small, the user has limited choices for the reservation. However, if the user can use any meeting room for each of the time slots constituting the desired time period, the user can achieve an object to do something using a meeting room. The user has only to change a meeting room, which is to be used, during the desired time period. That is, the user uses a meeting room until a time in the desired time period, and then moves to another meeting room available.

To flexibly search for meeting rooms for a desired time period, the meeting room reservation server 1 searches for combinations of two or more meeting rooms that would be reservable continuously throughout the desired time period if the meeting room to be reserved were changed for the desired time period. The meeting room reservation server 1 then cause the user terminal 2 to present, to a user, the result of the search for meeting rooms reservable throughout the desired time period and the result of the search for combinations of two or more meeting rooms reservable continuously throughout the desired time period in a mutually distinguishable form. The distinguishable form is, for example, a visually distinguishable form.

The following describes specific examples of a combination of two or more meeting rooms reservable continuously. FIG. 2A is a diagram showing an example of the reservation status of meeting rooms. For instance, assume that there are meeting rooms A to E. Additionally, assume that a user specifies the time period from 10:00 to 12:00 as a desired time period. As shown in FIG. 2A, the meeting room A is already reserved for 10:00 to 12:00. The meeting room B is reservable for the time period from 10:30 to 11:00 and the time period from 11:30 to 12:00. The meeting room C is reservable for the time period from 10:00 to 11:30. The meeting room D is reservable for the time period from 10:00 to 10:15, the time period from 11:00 to 11:15, and the time period from 11:45 to 12:00. The meeting room E is reservable for the time period from 10:00 to 10:30.

None of the meeting rooms A to E are reservable throughout the time period from 10:00 to 12:00. However, a combination of two or more meeting rooms would be reservable continuously throughout the desired time period if the meeting room to be reserved were changed during the period from 10:00 to 12:00. For instance, the meeting room C is reservable for 10:00 to 11:30, and the meeting room B is reservable for 11:30 to 12:00. Thus, a combination of the meeting rooms C and B can be retrieved. Additionally, for instance, the meeting room E is reservable for 10:00 to 10:30, the meeting room C is reservable for 10:30 to 11:30, and the meeting room B is reservable for 11:30 to 12:00. Thus, a combination of the meeting rooms E, C, and B can be retrieved. There are other combinations.

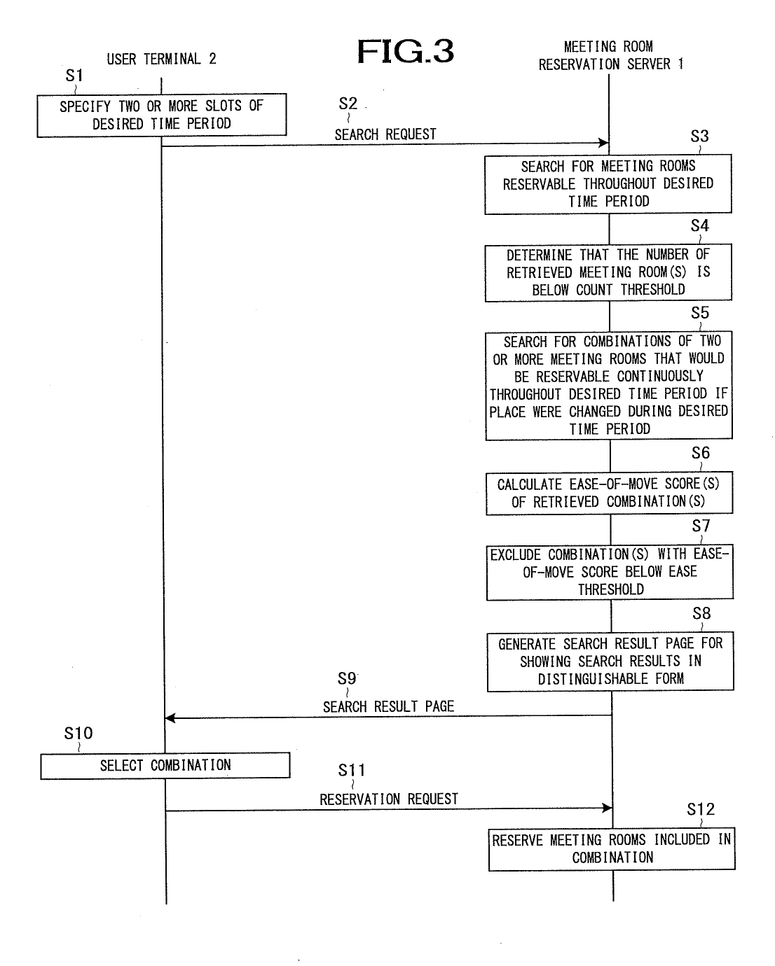

The following describes an operational overview of the information processing system S. FIG. 3 is a sequence diagram showing a process overview of the information processing system S according to the present embodiment. On the screen of the user terminal 2, a web page for specifying search criteria on the reservation site is displayed. For example, the search criteria can be specified on the home page. The user thereby specifies search criteria. Here assume that the user specifies a desired time period corresponding to continuous slots as shown in FIG. 3 (Step S1). Subsequently, the user terminal 2 sends a search request in response to the user's operation (Step S2). The search request is a message requesting a search for meeting rooms. The search request includes the desired time period specified by the user.

The meeting room reservation server 1 that has received the search request searches for meeting rooms throughout the desired time period (Step S3). The meeting room reservation server 1 then counts the number of the retrieved meeting room(s). Here assume that the meeting room reservation server 1 determines that the number of the retrieved meeting room(s) is below a predetermined count threshold (Step S4). In this case, the meeting room reservation server 1 searches for combinations of two or more meeting rooms that would be reservable continuously throughout the desired time period if a meeting room to be reserved were changed during the desired time period (Step S5). The meeting room reservation server 1, for example, may exclude the meeting rooms reservable throughout the desired time period from the combination(s) retrieved in Step S5.

On the other hand, when the number of the retrieved meeting room(s) is equal to or greater than the count threshold, the meeting room reservation server 1 skips Steps S4 and S5. That is because the user has some meeting rooms to select from and combinations of meeting rooms do not have to be searched. A reduction in the number of search processes can reduce the processing load of the meeting room reservation server 1. When the specified desired time period corresponds to only a single time slot, the meeting room reservation server 1 also skips Steps S4 and S5.

An administrator of the meeting room reservation server 1 can set the count threshold. The count threshold, for example, may be one, two, or more.

After Step S5, the meeting room reservation server 1 determines an ease-of-move degree for each of the combination(s) retrieved in Step S6 (Step S6). The ease-of-move degree indicates ease of moving between the meeting rooms constituting the combination. The meeting room reservation server 1 calculates, for instance, an ease-of-move score as information indicating the ease-of-move degree. The higher the ease-of-move score, the easier it is to move.

For example, when the positional relationship between the location of a source meeting room and the location of a destination meeting room is closer, the meeting room reservation server 1 may calculate the ease-of-move score to be higher. FIG. 2B is a diagram showing an example of calculation bases for the ease-of-move score. For example, attributes of a meeting room include the building in which the meeting room is and the floor on which the meeting room is. If the source meeting room and the destination meeting room are on the same floor in the same building, the meeting room reservation server 1 maximizes the ease-of-move score. If the destination meeting room and the source meeting room are on different floors in the same building, the meeting room reservation server 1 gives the second highest ease-of-move score. If the destination meeting room and the source meeting room are in different buildings, the meeting room reservation server 1 minimizes the ease-of-move score whether or not they are on the same floors. The meeting room reservation server 1 may calculates the ease-of-move score without reflecting the floor on which the meeting room is and only reflecting the building in which the meeting room is. For instance, when the distance or the travel time from the source meeting room to the destination meeting room is shorter, the meeting room reservation server 1 may calculate the ease-of-move score to be higher. The distance may be a linear distance or a travel distance.

For instance, when the number of meeting rooms included in the retrieved combination is smaller, the meeting room reservation server 1 may calculate the ease-of-move score to be higher. This is because more meeting rooms, causing more moves between them, may take some effort to move between.

After Step S6, the meeting room reservation server 1 excludes the combination(s), among the retrieved combination(s), with an ease-of-move score below a predetermined ease threshold from the search result (Step S7). That is, the meeting room reservation server 1 has only the combination(s) with an ease-of-move score equal to or greater than the ease threshold presented to the user. That is because the user is highly likely to select the combinations for easy moves from the combinations for easy moves and the combinations for uneasy moves. That is because the combination(s) for easy moves are more convenient for the user. Not presenting information about the less convenient combinations) allows the user to easily find information about the more convenient combination(s). The administrator of the meeting room reservation server 1 can freely set the ease threshold. The ease threshold is an example of predetermined ease according to the present invention.

The meeting room reservation server 1 may exclude the combination(s) that meet predetermined conditions from the search result without calculating the ease-of-move score(s). For instance, the meeting room reservation server 1 may exclude the combination(s) including the source meeting room and the destination meeting room that are in different buildings. In this case, it is an example of the predetermined ease according to the present invention that the source meeting room and the destination meeting room are in the same building. For instance, the meeting room reservation server 1 may exclude the combination(s) including meeting rooms numbered above a predetermined number. The predetermined number in this case is an example of the predetermined ease according to the present invention. The meeting room reservation server 1 may not perform the process for excluding the combination(s) from the search result based on ease of moving between the meeting rooms.

After Step 7, the meeting room reservation server 1 generates a search result page so that the result of the search for meeting rooms reservable throughout the desired time period in Step S3 and the result of the search for combinations in Step S5 are displayed in a distinguishable form (Step S8). The meeting room reservation server 1 sends the generated search result page to the user terminal 2 of the user (Step S9). The user terminal 2 displays the received search result page (Step S10).

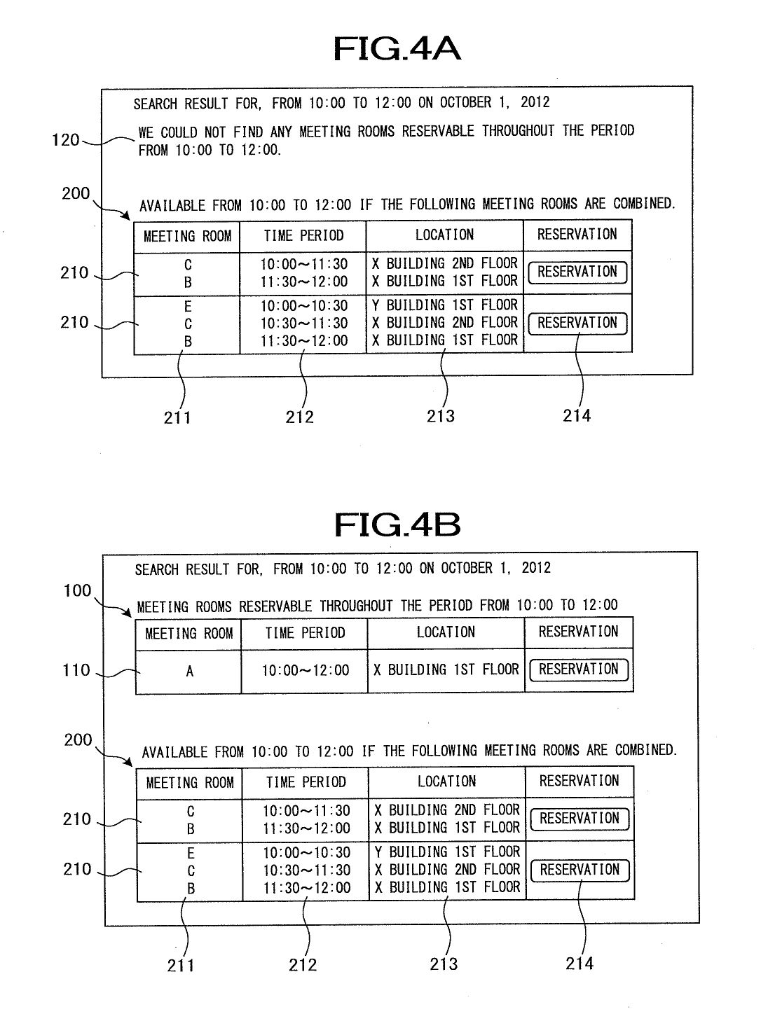

FIG. 4A is a diagram showing a display example of the search result page. FIG. 4A shows an example where the time period from 10:00 to 12:00 is specified as the desired time period and where the reservation status of the meeting rooms is the status shown in FIG. 2A. As shown in FIG. 4A, a message 120 and a search result area 200 are shown in the search result page. The message 120 is a message indicating that no meeting rooms could be retrieved as a result of the search for meeting rooms reservable throughout desired slots. For example, “We could not find any meeting rooms reservable throughout the period from 10:00 to 12:00.” may be shown as the message 120.

In the search result area 200, a list of the retrieved combination(s) is shown. Specifically, in the search result area 200, combination information 210 is shown for each of the retrieved combination(s). In the combination information 210, meeting room names 211, time periods 212, locations 213, and a reservation button 214 are shown. As the meeting room names 211, the names of the meeting rooms included in the combination are shown. As the time periods 212, available time periods of the meeting rooms included in the combination are shown. As the locations 213, information about the locations of the meeting rooms included in the combination are shown. The information about the location includes, for example, the name of the building in which the meeting room is and the name of the floor on which the meeting rooms is. The reservation button 214 is a button for reserving the combination. When the user selects the reservation button 214, for example, a web page for confirming whether to reserve it is displayed. If the user then chooses to reserve it, the reservation is completed.

As the message 120 and the search result area 200 are shown, the user can distinguish between the result of the search for meeting rooms reservable throughout the desired time period and the result of the search for combinations of two or more meeting rooms reservable continuously throughout the desired time period.

FIG. 4B is a diagram showing a display example of a search result page when a meeting room is reservable throughout the desired time period. For example, in FIG. 2A, assume that the meeting room A is reservable throughout the period from 10:00 to 12:00. In this case, as shown in FIG. 4B, a search result area 100 and the search result area 200 are shown in the search result page. A list of meeting rooms reservable throughout the desired time period is shown in the search result area 100. Specifically, a meeting room information 110 is shown for each of the retrieved meeting room(s) in the search result area 200. In the meeting room information 110, a meeting room name, a time period, a location, and a reservation button are shown. The result of the search for meeting rooms reservable throughout the desired time period and the result of the search for combinations of two or more meeting rooms reservable continuously throughout the desired time period are shown in different areas. Thus, the user can distinguish between the search results. The user can select a reservation object from the meeting rooms reservable throughout the desired time period and the combination(s) of two or more meeting rooms reservable continuously throughout the desired time period.

The display format for distinguishing between the result of the search for meeting rooms reservable throughout the desired time period and the result of the search for combinations of two or more meeting rooms reservable continuously throughout the desired time period is not limited to the display format shown in FIG. 4B. For example, the meeting room reservation server 1 may cause a tab corresponding to the meeting rooms reservable throughout the desired time period and a tab corresponding to the combinations of two or more meeting rooms reservable continuously throughout the desired time period to be distinguishably shown in the search result page. The meeting room reservation server 1 may generate the search result page so that the search result corresponding to the tab selected by the user is displayed. Elements to be selected are not limited to such tabs. The elements to be selected may be, for example, radio buttons or list boxes.

Alternatively, the meeting room reservation server 1, for example, may generate the search result page so that both of the search results are displayed within an area. In this case, only one meeting room name is shown in the meeting room information 110 and two or more meeting room names are shown in the combination information 210, so that the user can distinguish between the search results. For example, the meeting room reservation server 1 may generate the search result page so that the meeting room information 110 and the combination information 210 are different in at least one of area background color, area size, font color, font size, and font style, etc. In this case, the meeting room reservation server 1 may generate the search result page so that the display format of the meeting room information 110 is more visually recognizable than the display format of the combination information 210. Alternatively, for example, the meeting room reservation server 1 may generate the search result page so that letters or figures distinguishably indicating that it is the result of the search for combinations are shown in the combination information 210. Alternatively, for example, the meeting room reservation server 1 may generate the search result page so that letters or figures distinguishably indicating that it is the result of the search for meeting rooms reservable throughout the desired time period are shown in the meeting room information 110.

When the number of meeting rooms reservable throughout the desired time period is equal to or greater than the count threshold or when there is no combination of two or more meeting rooms reservable continuously throughout the desired time period, only the search result area 100 is shown. In this case, a particular message about the result of the search for combinations may not be shown.

Information about time periods and locations is not necessary as information shown in the search result page. It is only required that information identifying at least meeting rooms is shown. The information about time periods and locations, for example, may be shown in a web page for confirming whether to reserve it.

After the search result page is displayed, as shown in FIG. 3, when the user selects the reservation button 214 corresponding to any of the combination(s) from the search result area 200 (Step S10) and then determines to reserve it, the user terminal 2 sends a reservation request to the meeting room reservation server 1 (Step S11). The meeting room reservation server 1 that has received the reservation request reserves each of the meeting rooms included in the combination selected by the user (Step S12). For example, in the example shown in FIG. 2A, when the user selects the combination of the meeting rooms C and B, the meeting room reservation server 1 reserves the meeting room C for 10:00 to 11:30 and the meeting room B for 11:30 to 12:00.

### 3. Configuration of Meeting Room Reservation Server

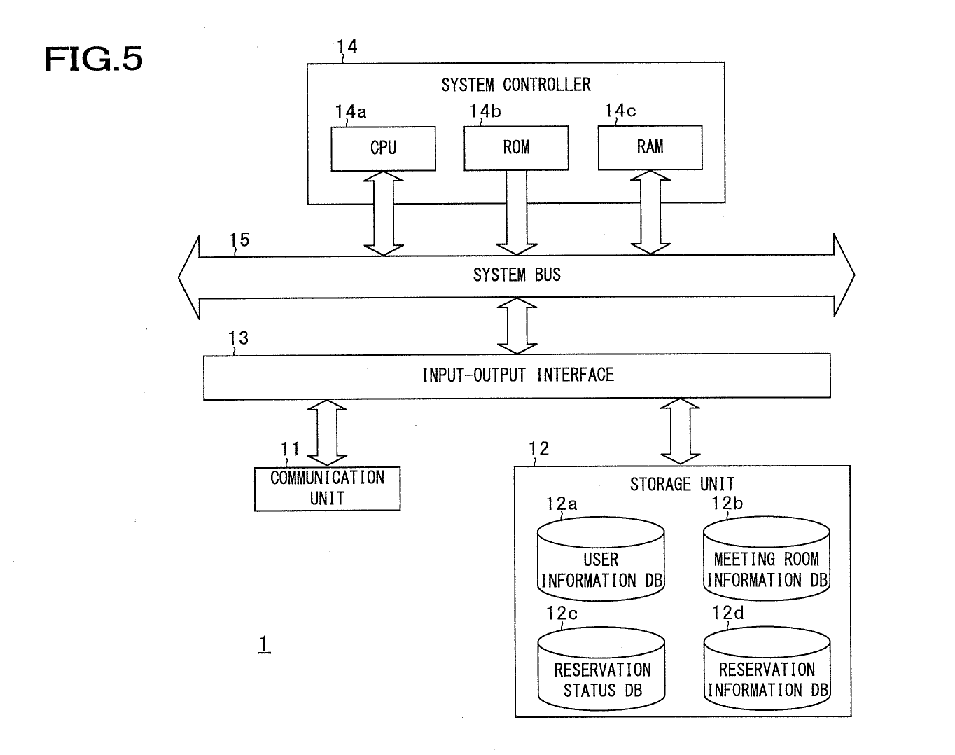

The following describes a configuration of the meeting room reservation server 1 with reference to FIGS. 5 to 7.

FIG. 5 is a block diagram showing an example of a schematic configuration of the meeting room reservation server 1 according to the present embodiment. As shown in FIG. 5, the meeting room reservation server 1 includes a communication unit 11, a storage unit 12, an input-output interface 13, and a system controller 14. The system controller 14 and the input-output interface 13 are connected via a system bus 15.

The communication unit 11 connects to the network NW and controls the state of communications with the user terminal 2 and the like.

The storage unit 12 includes, for example, a hard disk drive. In this storage unit 12, a user information DB 12a, a meeting room information DB 12b, a reservation status DB 12c, a reservation information DB 12d, and other databases are created. “DB” is an abbreviation for database.

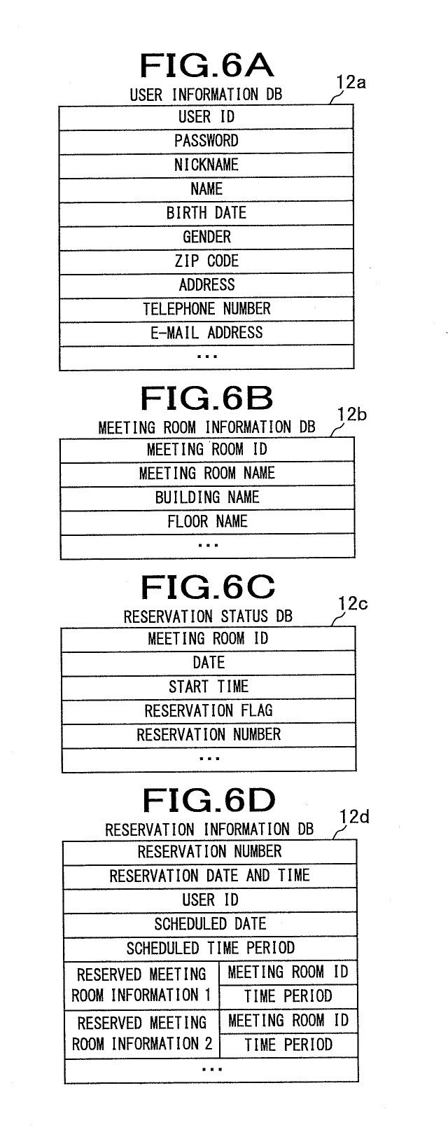

FIG. 6A is a diagram showing an example of information registered in the user information DB 12a. In the user information DB 12a, user information about users who use the reservation site is registered. Specifically, in the user information DB 12a, user attributes, such as a user ID, a password, a nickname, a name, a birth date, a gender, a zip code, an address, a telephone number, an e-mail address, are registered in association with each other for each user. The user ID is identification information of the user.

FIG. 6B is a diagram showing an example of information registered in the meeting room information DB 12b. In the meeting room information DB 12b, meeting room information about meeting rooms is registered. Specifically, in the meeting room information DB 12b, meeting room attributes, such as a meeting room ID, a meeting room name, a building name, and a floor name, are registered in association with each other for each meeting room. The meeting room ID is identification information of the meeting room. The meeting room name is the name of the meeting room. The building name is the name of the building in which the meeting room is. The floor name is the name of the floor on which the meeting room is.

FIG. 6C is a diagram showing an example of information registered in the reservation status DB 12c. In the reservation status DB 12c, the reservation status of each meeting room is registered. Specifically, in the meeting room information DB 12b, a meeting room ID, a date, a start time, a reservation flag, a reservation number, and the like are registered in association with each other for each combination of a meeting room, a date, and a time slot. The start time is the start time of the time slot. In the reservation flag, any of “reserved” and “available” is set. The “reserved” indicates that the time slot is a reserved slot. The “available” indicates that the time slot is an available slot. The reservation number is an identification number that is issued every time a reservation is completed. The reservation number is registered when the reservation flag is “reserved”. When continuous slots are reserved, the same reservation number is registered in association with the start time of each of the time slots corresponding to the continuous slots.

FIG. 4D is a diagram showing an example of information registered in the reservation information DB 12d. In the reservation information DB 12d, reservation information indicating reservation details of meeting rooms is registered. Specifically, in the reservation information DB 12d, a reservation number, a reservation date and time, a user ID, a scheduled date, a scheduled time period, reserved meeting room information, and the like are registered. The reservation number is information identifying the reservation information. The reservation date and time is the date and time when a reservation was made. The user ID indicates the user who made the reservation. The scheduled date is a date reserved as the date when meeting room(s) are scheduled to be used. The scheduled time period indicates a time period reserved as the time period during which the user is scheduled to use the meeting room(s). The scheduled time period corresponds to the desired time period. The reserved meeting room information is information about the reserved meeting room. When a meeting room reservable throughout the scheduled time period has be reserved, one reserved meeting room information is registered. When a combination of two or more meeting rooms reservable continuously throughout the scheduled time period is reserved, the reserved meeting room information is registered for each of the meeting rooms included in the combination. In the reserved meeting room information, a meeting room ID and a time period are set. The meeting room ID indicates the reserved meeting room. The time period indicates the time period for which the meeting room indicated by the meeting room ID is reserved.

The following describes other information stored in the storage unit 12. The storage unit 12 stores various data, such as HTML documents, extensible markup language (XML) documents, image data, text data, and electronic documents, for displaying web pages. The storage unit 12 also stores various setting values, threshold values, constants, and the like.

The storage unit 12 also stores various programs, such as an operating system, a World Wide Web (WWW) server program, a database management system (DBMS), and a reservation management program. The reservation management program is a program for performing various processes related to reserving meeting rooms. The reservation management program is an example of an information processing program according to the present invention. The various programs, for example, may be acquired from another server device or the like via the network NW, or may be recorded in a recording medium, such as a digital versatile disc (DVD), and read via a drive device. The reservation management program may be a program product.

The input-output interface 13 performs interface processing between the communication unit 11 and the storage unit 12, and the system controller 14.

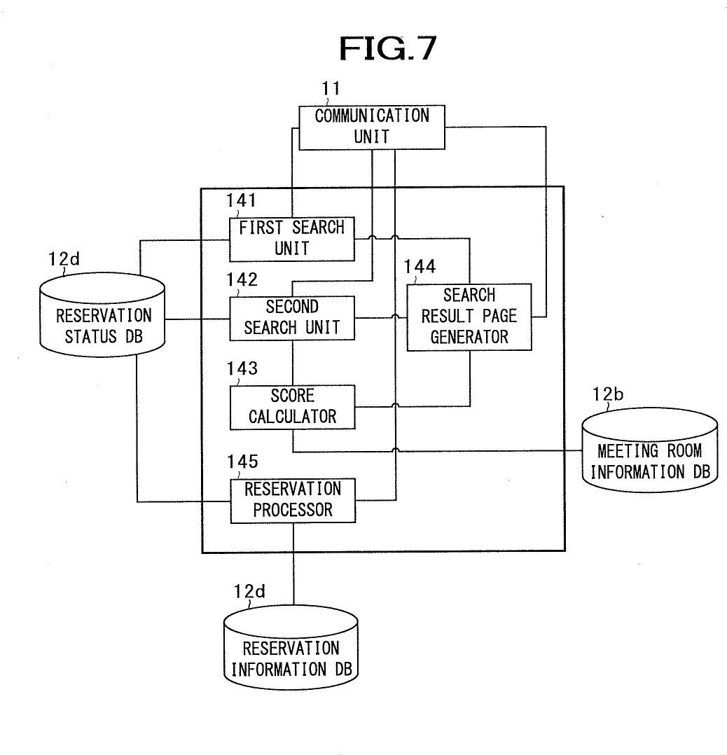

FIG. 7 is a diagram showing an example of functional blocks of the meeting room reservation server 1 according to the present embodiment. The system controller 14 includes a CPU 14a, a read only memory (ROM) 14b, a random access memory (RAM) 14c, and the like. As shown in FIG. 7, the various programs, read and executed by the CPU 14a, enable the system controller 14 to function as a first search unit 141, a second search unit 142, a score calculator 143, a search result page generator 144, and a reservation processor 145. The first search unit 141 is an example of identifying means and first search means according to the present invention. The second search unit 142 is an example of second search means according to the present invention. The score calculator 143 is an example of determining means according to the present invention. The search result page generator 144 is an example of presentation control means according to the present invention.

The first search unit 141 identifies a desired time period based on a start time and an end time included in a search request sent from the user terminal 2. The first search unit 141 then searches for meeting rooms reservable throughout the desired time period.

When the specified desired time period corresponds to continuous slots, the second search unit 142 searches for combinations of two or more meeting rooms that would be reservable continuously throughout the desired time period if the meeting room to be reserved were changed during the desired time period.

The score calculator 143 calculates the ease-of-move score(s) of the combination(s) retrieved by the second search unit.

The search result page generator 144 generates an HTML document of a search result page based on the results of the searches by the first search unit 141 and the second search unit 142. The search result page generator 144 also determines which combination among the retrieved combination(s) to exclude from the search result, based on the ease-of-move score(s) calculated by the score calculator 143. The search result page generator 144 sends the generated HTML document to cause the user terminal 2 to present the result of the search by the first search unit 141 and the result of the search by the second search unit 142 in a mutually distinguishable form.

The reservation processor 145 updates the reservation status, registers reservation information, and so on.

The meeting room reservation server 1 may include a plurality of server devices. For example, server devices, such as a server device that searches for meeting rooms on the reservation site, a server device that handles reservations, a server device that sends web pages in response to requests from the user terminal 2, and a server device that manages databases, may be connected to each other via a LAN or the like.

### 4. Operation of Information Processing System

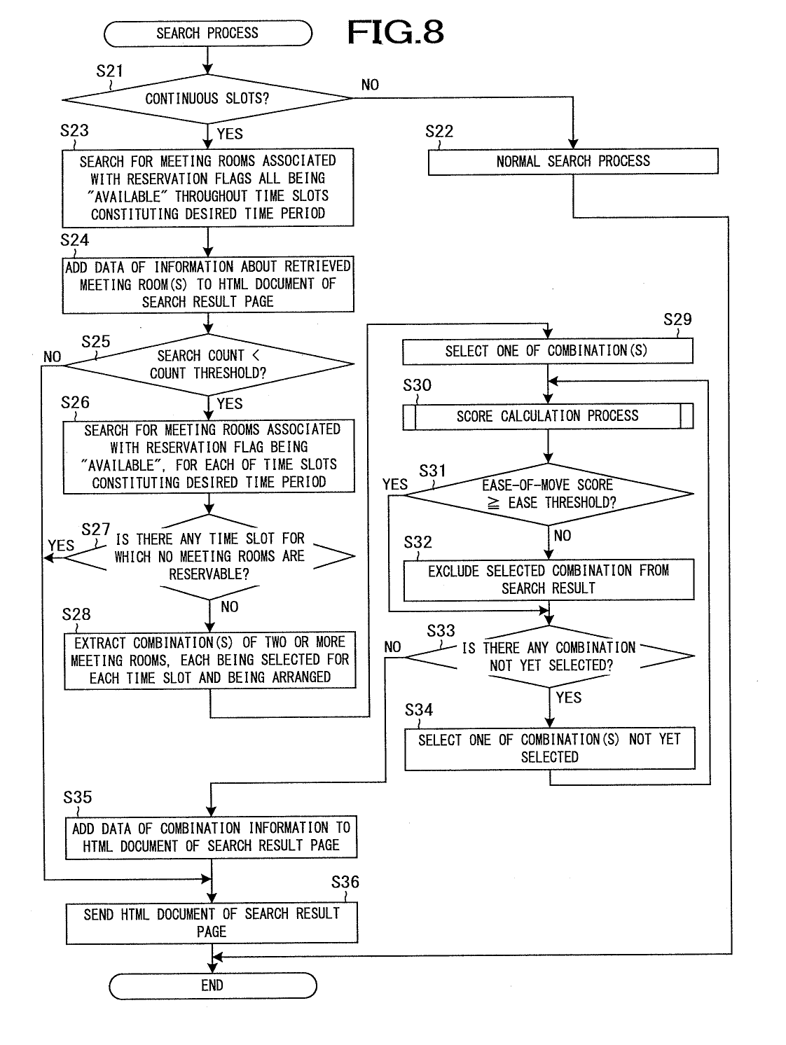

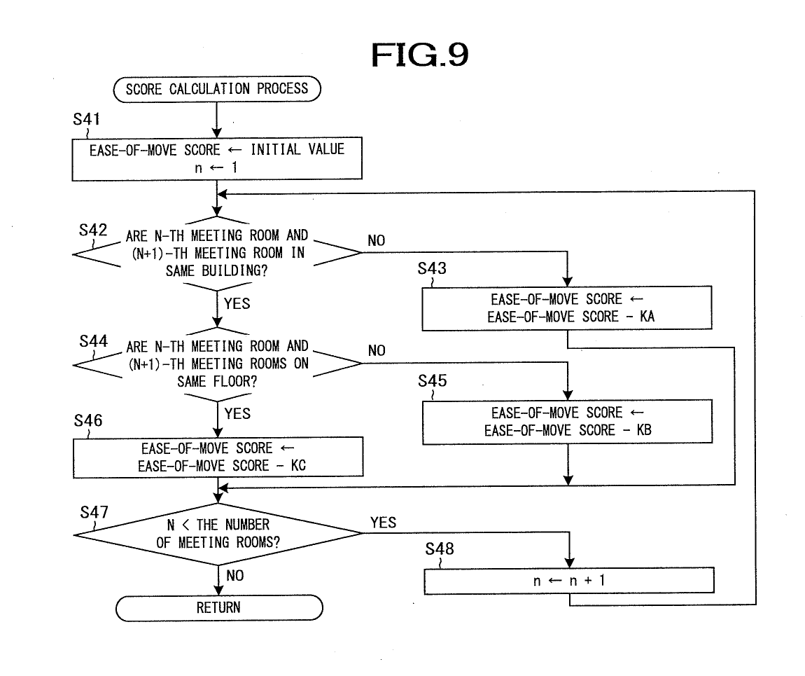

The following describes an operation of the information processing system S with reference to FIGS. 8 and 9. An example operation described below is an example where such search result pages as are shown in FIGS. 4A and 4B is displayed.

FIG. 8 is a flowchart showing an example process of the search process performed by the system controller 14 of the meeting room reservation server 1 according to the present embodiment. On the home page, a user selects a scheduled date, for example, and selects the start time and the end time of a desired time period. Then the user terminal 2 sends a search request to the meeting room reservation server 1. The search request includes the scheduled date, the start time, and the end time specified and selected by the user. The search process is started when the meeting room reservation server 1 receives the search request.

The first search unit 141 identifies the desired time period from the start time and the end time set in the search request. Then first search unit 141 determines whether the desired time period is a time period corresponding to continuous slots (Step S21). If the first search unit 141 here determines that the desired time period is a time period corresponding to continuous slots (YES in Step S21), the first search unit 141 proceeds to Step S23. On the other hand, if the first search unit 141 determines that the desired time period is not a time period corresponding to continuous slots (NO in Step S21), the first search unit 141 proceeds to Step S22.

In Step S22, a normal search process is performed. Specifically, the first search unit 141 searches for meeting rooms reservable during the desired time period. The search result page generator 144 generates an HTML document of the search result based on the result of the search by the first search unit 141. Subsequently, the search result page generator 144 sends the generated HTML document to the user terminal 2. The search result page generator 144 then terminates the search process.

In Step S23, the first search unit 141 searches for meeting rooms reservable throughout the desired time period. Specifically, the first search unit 141 identifies the start times of the individual time slots constituting the continuous slots corresponding to the desired time period. Subsequently, for each of the meeting rooms, the first search unit 141 obtains the reservation flags associated with the identified start times of the individual time slots among the reservation flags associated with the scheduled date set in the search request and the meeting room ID in the reservation status DB 12c. If all of the obtained reservation flags are “available”, the meeting room reservation server 1 determines that the meeting room identified by the corresponding meeting room ID is a meeting room reservable throughout the desired time period.

Subsequently, the search result page generator 144 adds data for showing the meeting room information 110 of the retrieved meeting room(s) to a template of an HTML document of a search result page (Step S24). Thus, the search result page generator 144 generates the HTML document of the search result page including the search result area 100. If no meeting rooms are reservable throughout the desired time period, the search result page generator 144 adds data of the message 120 to the template.

Then the search result page generator 144 determines whether the number of the retrieved meeting room(s) is below the count threshold stored in the storage unit 12 (Step S25). If the search result page generator 144 here determines that the number of the meeting rooms is below the count threshold (YES in Step S25), the search result page generator 144 proceeds to Step S26. On the other hand, if the search result page generator 144 determines that the number of the meeting rooms is equal to or greater than the count threshold (NO in Step S25), the search result page generator 144 proceeds to S36.

In Step S26, the second search unit 142 searches for meeting rooms reservable for each of the time slots constituting the desired time period. Specifically, for each of the start times of the time slots constituting the desired time period, the second search unit 142 searches the reservation status DB 12c for the meeting room IDs associated with the reservation flag being “available” among the meeting room IDs associated with the scheduled date.

Subsequently, the second search unit 142 determines whether there is at least one time slot for which no meeting rooms are reservable among the plurality of time slots constituting the desired time period, based on the search result in Step S26 (Step S27). If the second search unit 142 here determines that there is a time slot for which no meeting rooms are reservable (YES in Step S27), the second search unit 142 proceeds to Step S36. In this case, there is not a combination of two or more meeting rooms reservable continuously throughout the desired time period. On the other hand, if the second search unit 142 determines that there is not a time slot for which no meeting rooms are reservable (NO in Step S27), the second search unit 142 proceeds to Step S28.

In Step S28, the second search unit 142 extracts combinations) of two or more meeting rooms, each being selected one by one from the meeting rooms) reservable for each time slot and being arranged, based on the result of the search for meeting rooms for each of the time slots constituting the desired time period. For example, assume that three continuous slots from 12:00 to 12:45 are specified as the desired time period. Also assume that the meeting rooms A, B, and C are retrieved for the time slot starting at 12:00, that the meeting rooms A and B are retrieved for the time slot starting at 12:15, and that the meeting room D is retrieved for the time slot starting at 12:30. In this case, (A, A, D), (A, B, D), (B, A, D), (B, B, D), (C, A, D), and (C, B, D) are obtained as the combinations. Elements in each of the combinations are associated with different time slots. Thus, the combinations (A, B, D) and (B, A, D) are different. When the same meeting rooms are continuously arranged like (A, A, D) and (B, B, D), the second search unit 142 integrates the same continuous meeting rooms into one. The second search unit 142 then associates a slot count with each meeting room. For example, (A, A, D) is a combination of the meeting rooms A and D, and 2 slots are associated with the meeting room A and 1 slot with the meeting room B. When the number of the meeting rooms included in the combination becomes one as a result of the integration, the second search unit 142 excludes the combination from the extraction result. For example, (E, E, E) becomes (E), so that it is excluded from the extraction result. The meeting room E in this case is a meeting room reservable throughout the desired time period. Through Steps S26 to S28, the second search unit 142 searches for combinations of two or more meeting rooms that would be reservable continuously throughout the desired time period if the meeting room to be reserved were changed during the desired time period.

Subsequently, the search result page generator 144 selects one of the extracted combination(s) (Step S29). Then the score calculator 143 performs a score calculation process (Step S30). In the score calculation process, the ease-of-move score of the selected combination is calculated. The score calculation process is described below. The search result page generator 144 then determines whether the calculated ease-of-move score is equal to or greater than the ease threshold stored in the storage unit 12 (Step S31). If the search result page generator 144 here determines that the ease-of-move score is equal to or greater than the ease threshold (YES in Step S31), the search result page generator 144 proceeds to Step S33. On the other hand, if the search result page generator 144 determines that the ease-of-move score is below the ease threshold (NO in Step S31), the search result page generator 144 proceeds to Step S32. In Step S32, the search result page generator 144 excludes the selected combination from the search result. The search result page generator 144 then proceeds to Step S33.

In Step S33, the search result page generator 144 determines whether there is any combination that is not yet selected among the extracted combination(s). If the search result page generator 144 here determines that there is a combination not yet selected (YES in Step S33), the search result page generator 144 proceeds to Step S34. In Step S34, the search result page generator 144 selects one of the combination(s) not yet selected. The search result page generator 144 then proceeds to Step S30. On the other hand, if the search result page generator 144 determines that all of the combination(s) are selected (NO in Step S33), the search result page generator 144 proceeds to Step S35.

In Step S35, the search result page generator 144 adds data for showing the combination information 210 of the retrieved combination(s) to the HTML document of the search result page. Thus, the search result page generator 144 generates the HTML document of the search result page including the search result area 200. Subsequently, the search result page generator 144 sends the generated HTML document to the user terminal 2 (Step S36). The search result page generator 144 then terminates the search process.

FIG. 9 is a flowchart showing an example process of the score calculation process performed by the system controller 14 of the meeting room reservation server 1 according to the present embodiment. FIG. 9 shows an example where ease-of-move score(s) are calculated based on the positional relationship of meeting rooms.

As shown in FIG. 9, the score calculator 143 sets an initial value stored in the storage unit 12 to the ease-of-move score. The score calculator 143 also sets 1 to an index n (Step S41).

Then the score calculator 143 determines whether the n-th meeting room and the (n+1)-th meeting room included in the selected combination are in the same building (Step S42). The score calculator 143 can identify the buildings in which the meeting rooms are by referring to the meeting room information DB 12b. If the score calculator 143 determines that the n-th meeting room and the (n+1)-th meeting room are in the same building (YES in Step S42), the score calculator 143 proceeds to Step S44. On the other hand, if the score calculator 143 determines that the n-th meeting room and the (n+1)-th meeting room are in different buildings (NO in Step S42), the score calculator 143 proceeds to Step S43. In Step S43, the score calculator 143 subtracts a value KA stored in the storage unit 12 from the ease-of-move score. KA is a positive constant. The score calculator 143 then proceeds to Step S47.

In Step S44, the score calculator 143 determines whether the n-th meeting room and the (n+1)-th meeting room are on the same floor. The score calculator 143 can identify the floors on which the meeting rooms are by referring to the meeting room information DB 12b. If the score calculator 143 determines that the n-th meeting room and the (n+1)-th meeting room are on the same floor (YES in Step S44), the score calculator 143 proceeds to Step S46. On the other hand, if the score calculator 143 determines that the n-th meeting room and the (n+1)-th meeting room are on different floors (NO in Step S44), the score calculator 143 proceeds to Step S45. In Step S45, the score calculator 143 subtracts a value KB stored in the storage unit 12 from the ease-of-move score. KB is a positive constant. KB is smaller than KA. The score calculator 143 then proceeds to Step S47.

In Step S46, the score calculator 143 subtracts a value KC stored in the storage unit 12 from the ease-of-move score. KC is a positive constant. KC is smaller than KB. The score calculator 143 then proceeds to Step S47.

In Step S47, the score calculator 143 determines whether the index n is less than the number of the meeting rooms included in the combination. If the score calculator 143 here determines that the index n is smaller than the number of the meeting rooms (YES in Step S47), the score calculator 143 proceeds to Step S48. In Step S48, the score calculator 143 adds 1 to the index n. The score calculator 143 then proceeds to Step S42. On the other hand, if the score calculator 143 determines that the index n is equal to the number of the meeting rooms (NO in Step S47), the score calculator 143 terminates the score calculation process.

In the example of FIG. 9, the greater the number of the meeting rooms included in the combination, the greater the number of subtraction operations for the ease-of-move score is. Thus, when the number of the meeting rooms included in the combination is greater, the score calculator 143 calculates the ease-of-move score to be lower. The score calculator 143, for example, may calculate the ease-of-move score not based on the positional relationship between meeting rooms but based on the number of the meeting rooms included in the combination. For example, the score calculator 143 may divide KD by the number of the meeting rooms to get the ease-of-move score. KD is a positive constant.

As described above, according to the present embodiment, the system controller 14 identifies a desired time period for a user to use a meeting room, searches for meeting rooms reservable throughout the identified desired time period, searches for combinations of two or more meeting rooms that would be reservable continuously throughout the identified desired time period if the meeting room to be reserved were changed during the desired time period, and causes the result of the search for meeting rooms reservable throughout the desired time period and the result of the search for combinations of two or more meeting rooms reservable continuously throughout the desired time period to be presented in a mutually distinguishable form. Therefore, it is possible to flexibly search for meeting rooms that are reservable for a time period desired by a user.

The system controller 14 determines ease of moving between the meeting rooms included in the retrieved combination(s). Among the retrieved combination(s), the system controller 14 causes the combination(s) with the determined ease that is equal to or greater than the predetermined ease to be presented. Thus, only the convenient combination(s) to move can be presented, so that the user can easily find a convenient combination to move from the search result.

When the positional relationship between the source meeting room and the destination meeting room is closer, the system controller 14 may determine that it is easier to move. In this case, the ease of move can be properly determined.

When the number of meeting rooms included in the retrieved combination(s) is smaller, the system controller 14 may determines that it is easier to move. In this case, the ease of move can be properly determined.

In the embodiment described above, a meeting room represents a place according to the present invention. However, the place according to the present invention may be any place that can be reserved for a specified time period. The places according to the present invention may be, for example, a gymnasium, an athletic facility such as a golf course, or an assembly hall.

In the embodiment described above, a server device in a client-server system represents an information processing apparatus according to the present invention. However, the information processing apparatus according to the present invention may be an information processing apparatus other than the server device. For example, the information processing apparatus according to the present invention may be the user terminal 2 or the like. For example, a controller included in the information processing apparatus may function as means according to the present invention and thus cause display means such as a display to present search results according to the present invention. In this case, the display means may be included in the information processing apparatus. Alternatively, the display means maybe a device separate from the information processing apparatus.

### REFERENCE SIGNS LIST

1 meeting room reservation server
2 user terminal
11 communication unit
12 storage unit
12a user information DB
12b meeting room information DB
12c reservation status DB
12d reservation information DB
13 input-output interface
14 system controller
14a CPU
14b ROM
14c RAM
15 system bus
141 first search unit
142 second search unit
143 score calculator
144 search result page generator
145 reservation processor
NW network
S information processing system

1-6. (canceled)

7. An information processing apparatus comprising:
at least one memory operable to store program instructions;
at least one processor operable to access said memory, read said program instructions, and operate according to said program instructions, said program instructions including:
identifying instructions that cause at least one of said at least one processors to identify a desired time period for which any of a plurality of predetermined places is to be used;
first search instructions that cause at least one of said at least one processors to searche a set of the plurality of predetermined places for places reservable throughout the desired time period identified by the identifying instructions;
second search instructions that cause at least one of said at least one processors to search the set of the plurality of predetermined places for combinations of two or more places that would be reservable continuously throughout the desired time period identified by the identifying instructions if a place to be reserved were changed during the desired time period; and
presentation control instructions that cause at least one of said at least one processors to cause a search result from the first search instructions and a search result from the second search instructions to be presented in a mutually distinguishable form.

8. The information processing apparatus according to claim 7, further comprising
determining instructions that cause at least one of said at least one processors to determine ease of moving between the places included in each of one or more combinations retrieved by the second search instructions, wherein
among the one or more combinations retrieved by the second search instructions, the presentation control instructions cause at least one of said at least one processors to cause one or more combinations with ease, determined by the determining instructions. equal to or greater than predetermined ease to be presented.

9. The information processing apparatus according to claim 8, wherein
when a positional relationship between a source place and a destination place is closer, the determining instructions cause at least one of said at least one processors to determine that it is easier to move.

10. The information processing apparatus according to claim 8, wherein
when the number of the places included in a combination retrieved by the second search means is smaller, the presentation control instructions cause at least one of said at least one processors to determine that it is easier to move.

11. The information processing apparatus according to claim 9, wherein
when the number of the places included in a combination retrieved by the second search instructions is smaller, the presentation control instructions cause at least one of said at least one processors to determine that it is easier to move.

12. An information processing method performed by a computer, the method comprising:
identifying a desired time period for which any of a plurality of predetermined places is to be used;
searching a set of the plurality of predetermined places for places reservable throughout the desired time period identified;
searching the set of the plurality of predetermined places for combinations of two or more places that would be reservable continuously throughout the desired time period identified if a place to be reserved were changed during the desired time period; and
causing a search result from the searched places reservable and a search result from the searched combinations of two or more places reservable to be presented in a mutually distinguishable form.

13. A non-transitory computer readable medium storing thereon an information processing program, the information processing program causing a computer to:
identify a desired time period for which any of a plurality of predetermined places is to be used;
search a set of the plurality of predetermined places for places reservable throughout the desired time period identified;
search the set of the plurality of predetermined places for combinations of two or more places that would be reservable continuously throughout the desired time period identified if a place to be reserved were changed during the desired time period; and
cause a search result from the searched places reservable and a search result from the searched combinations of two or more places reservable to be presented in a mutually distinguishable form.
